(19) United States
(12) Patent Application Publication
(10) Pub. No.: US 2016/0078896 A1
(43) Pub. Date: Mar. 17, 2016

(54) SPINDLE MOTOR AND HARD DISK DRIVE INCLUDING THE SAME

(71) Applicant: SAMSUNG ELECTRO-MECHANICS CO., LTD., Suwon-si (KR)

(72) Inventor: Hoon Hee HAN, Suwon-si (KR)

(73) Assignee: SAMSUNG ELECTRO-MECHANICS CO., LTD., Suwon-si (KR)

(21) Appl. No.: 14/664,082

(22) Filed: Mar. 20, 2015

(30) Foreign Application Priority Data
Sep. 17, 2014 (KR) 10-2014-0123601

(51) Int. Cl. G11B 19/20; H02K 7/08

(52) U.S. Cl. CPC G11B 19/2036; H02K 7/086

(57) ABSTRACT

A spindle motor includes a stator, and a rotor forming a bearing clearance with the stator. The rotor is provided with an insertion groove formed therein into which a portion of the stator is inserted, and first and second sealing parts having liquid-vapor interfaces formed therein, respectively, are formed inside and outside the insertion groove, respectively. The first and second sealing parts are in communication with each other via a connection hole.

### CROSS-REFERENCE TO RELATED APPLICATION

This application claims the priority and benefit of Korean Patent Application No. 10-2014-0123601 filed on Sep. 17, 2014, with the Korean Intellectual Property Office, the disclosure of which is incorporated herein by reference.

### BACKGROUND

The present disclosure relates to a spindle motor and a hard disk drive including the same.

A small sized spindle motor used in a hard disk drive (HDD) is generally provided with a hydrodynamic bearing assembly, and a bearing clearance of the hydrodynamic bearing assembly is commonly filled with a lubricating fluid such as oil. Fluid dynamic pressure is generated in the oil filling the bearing clearance, as described above, while the oil is compressed, thereby rotatably supporting a rotor.

Meanwhile, in the case in which negative pressure is generated in the bearing clearance or external impacts are applied to the spindle motor, the lubricating fluid such as the oil filling the bearing clearance may moves to one side, such that lubricating fluid may be leaked to the outside of the bearing clearance.

In the case in which the lubricating fluid leaked to the outside as described above is scattered, an inner portion of the spindle motor may be contaminated by the lubricating fluid.

In addition, in the case in which the lubricating fluid is leaked to the outside, the fluid dynamic pressure generated by the lubricating fluid may be decreased, such that performance of the spindle motor may be deteriorated and a lifespan thereof shortened.

### RELATED ART DOCUMENT

(Patent Document 1) Korean Patent Laid-Open Publication No. 2014-0080839

### SUMMARY

An aspect of the present disclosure may provide a spindle motor capable of preventing leakage of a lubricating fluid, and a hard disk drive including the same.

According to an aspect of the present disclosure, a spindle motor may include a stator, and a rotor forming a bearing clearance with the stator, wherein the rotor is provided with an insertion groove formed therein into which a portion of the stator is inserted, and first and second sealing parts having liquid-vapor interfaces formed therein, respectively, are formed inside and outside the insertion groove, respectively, the first and second sealing parts being in communication with each other via a connection hole.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a view for describing an operation of the spindle motor according to an exemplary embodiment of the present disclosure;

FIG. 4 is a schematic cross-sectional view showing a spindle motor according to another exemplary embodiment of the present disclosure; and

FIG. 5 is a schematic cross-sectional view showing a hard disk drive according to an exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

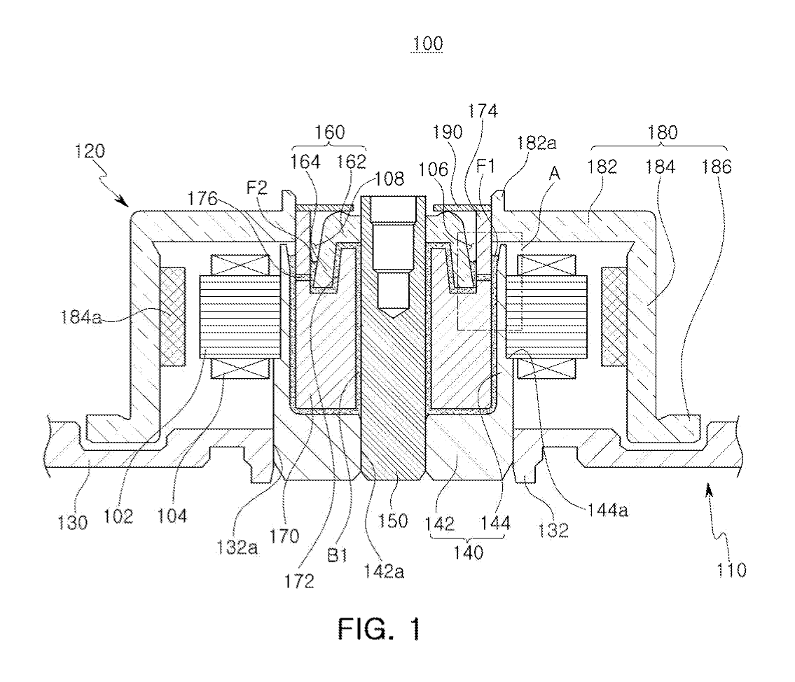

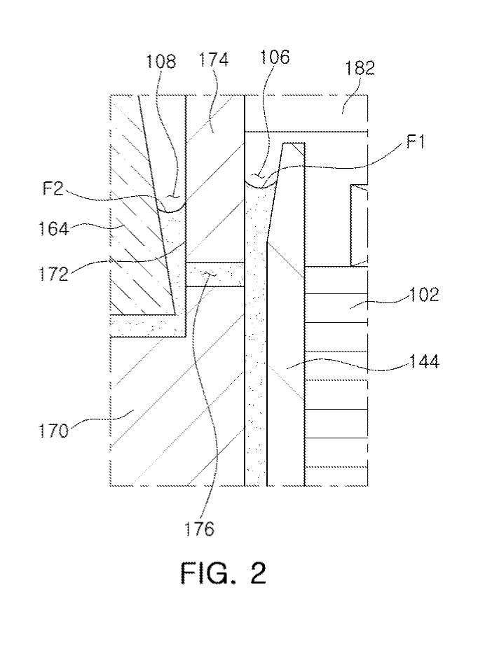

FIG. 1 is a schematic cross-sectional view showing a spindle motor according to an exemplary embodiment of the present disclosure; and FIG. 2 is an enlarged view of part A of FIG. 1.

Referring to FIGS. 1 and 2, a spindle motor 100 according to an exemplary embodiment of the present disclosure may include a stator 110 and a rotor 120 by way of example.

The stator 110 and the rotor 120 may form a bearing clearance B1 to be described below therebetween, and the rotor 120 may more stably rotate through dynamic pressure by pumping of a lubricating fluid filled in the bearing clearance B1.

The stator 110 may include a base member 130, a lower thrust member 140, a shaft 150, and an upper thrust member 160 by way of example. In addition, the rotor 120 may include a sleeve 170 and a rotor hub 180.

Here, terms with respect to directions will be defined. As viewed in FIG. 1, an axial direction refers to a vertical direction, that is, a direction from a lower end portion of the shaft 150 toward an upper end portion thereof or a direction from the upper end portion of the shaft 150 toward the lower end portion thereof, and a radial direction refers to a horizontal direction, that is, a direction from an outer peripheral surface of the rotor hub 180 toward the shaft 150 or a direction from the shaft 150 toward the outer peripheral surface of the rotor hub 180.

In addition, a circumferential direction refers to a rotation direction along an outer peripheral surface of the shaft 150 or the rotor hub 180.

The base member 130 may include an installation part 132 protruding in an upward axial direction and having the lower thrust member 140 inserted thereinto. That is, the installation part 132 may include an installation hole 132a so that a lower end portion of the lower thrust member 140 may be inserted thereinto.

In addition, the base member 130 may be formed by performing press working on a steel sheet or be formed by performing die-casting on aluminum.

The lower thrust member 140 may be fixedly installed in the installation part 132 of the base member 130, as described above. Meanwhile, the lower thrust member 140 may include a disk part 142 provided with a mounting hole 142a into which the shaft 150 is inserted, and a sealing wall portion 144 extended from an edge of the disk part 142.

An inner peripheral surface of an upper end portion of the sealing wall portion 144 may be inclined so that a first liquid-vapor interface F1 may be formed. In addition, the inner peripheral surface of the upper end portion of the sealing wall portion 144 and an outer surface of the sleeve 170 disposed to face the inner peripheral surface of the upper end portion of the sealing wall portion 144 may form a first sealing part 106 in which the first liquid-vapor interface F1 described above is disposed.

In addition, the lower thrust member 140 may form the bearing clearance B1 in which the lubricating fluid is filled, with the sleeve 170.

Meanwhile, the sealing wall portion 144 may have a stator core 102 fixedly installed on an outer peripheral surface thereof. In addition, the sealing wall portion 144 may have a support surface 144a formed on the outer peripheral surface thereof in order to support a lower surface of the stator core 102.

The shaft 150 may have a lower end portion inserted into the mounting hole 142a of the lower thrust member 140 and have the upper thrust member 160 installed on an upper end portion thereof. Meanwhile, the rotor 120 may rotate around the shaft 150. That is, the spindle motor 100 according to the present exemplary embodiment may have a fixed shaft structure in which the shaft 150 is fixed.

In addition, the shaft 150 may also form the bearing clearance B1 in which the lubricating fluid is filled, with the sleeve 170 of the rotor 120.

The upper thrust member 160 may be installed on the upper end portion of the shaft 150. Meanwhile, the upper thrust member 160 may include a body part 162 having a disk shape and an extension wall portion 164 extended from an edge of the body part 162.

In addition, the extension wall portion 164 may be inserted into an insertion groove 172 of the sleeve 170 to be described below. In addition, an outer peripheral surface of the extension wall portion 164 may form a second sealing part 108 in which a second liquid-vapor interface F2 is disposed, with an inner peripheral surface of an outer wall portion 174 of the sleeve 170 to be described below.

Here, the bearing clearance B1 will be described in more detail. First, the lower thrust member 140 may form the bearing clearance with a lower surface and an outer peripheral surface of the sleeve 170. That is, an upper surface of the disk part 142 and the lower surface of the sleeve 170 may form the bearing clearance, and the inner peripheral surface of the sealing wall portion 144 may form the bearing clearance with the outer peripheral surface of the sleeve 170.

In addition, an outer peripheral surface of the shaft 150 and the inner peripheral surface of the sleeve 170 may be disposed to be spaced apart from each other by a predetermined interval to form the bearing clearance.

Further, the bearing clearance may be formed by the sleeve 170 and the upper thrust member 160. That is, the bearing clearance may be formed by an upper surface of the sleeve 170 and a lower surface of the body part 162 of the upper thrust member 160, and an inner peripheral surface, a lower surface, and the outer peripheral surface of the extension wall portion 164 of the upper thrust member 160 and facing surfaces of the sleeve 170 disposed to face the inner peripheral surface, the lower surface, and the outer peripheral surface of the extension wall portion 164 of the upper thrust member 160 may also form the bearing clearance.

The rotor 120 may form the bearing clearance B1 with the stator 110, as described above, and be provided with the insertion groove 172 into which a portion of the stator 110 is inserted, and the first and second sealing parts 106 and 108 having the first and second liquid-vapor interfaces F1 and F2 formed therein, respectively, may be formed inside and outside the insertion groove 172, respectively.

Further, the first and second sealing parts 106 and 108 may be in communication with each other via a connection hole 176.

A detailed description therefor will be provided below.

The rotor 120 may include the sleeve 170 and the rotor hub 180, as described above.

The sleeve 170 may be installed to be rotatable around the shaft 150 and include the insertion groove 172 into which the extension wall portion 164 of the upper thrust member 160 is inserted.

Meanwhile, the sleeve 170 may include the outer wall portion 174 forming the first and second sealing parts 106 and 108 so that the first and second liquid-vapor interfaces F1 and F2 are formed on the outer peripheral surface and the inner peripheral surface of the sleeve.

In addition, upper and lower radial dynamic grooves (not shown) pumping the lubricating fluid filled in the bearing clearance B1 to generate fluid dynamic pressure may be formed in at least one of the inner peripheral surface of the sleeve 170 and the outer peripheral surface of the shaft 150.

Meanwhile, negative pressure may be generated in the bearing clearance B1 at the time of rotation of the sleeve 170. In this case, the lubricating fluid may move by pressure difference within the bearing clearance B1.

Therefore, the connection hole 176 may be formed in the outer wall portion 174 of the sleeve 170 in order to decrease an amount of the lubricating fluid moving by the pressure difference within the bearing clearance B1.

That is, leakage of the lubricating fluid from the first and second sealing parts 106 and 108 to the outside may be prevented through the connection hole 176 connecting the first and second sealing parts 106 and 108 to each other.

In more detail, when the negative pressure is generated in the bearing clearance B1 or external impact is applied to the spindle motor, the lubricating fluid may move by the pressure difference. However, in the case in which the connection hole 176 is not formed, a spaced distance between the first and second sealing parts 106 and 108, that is, a spaced distance on a path through which the lubricating fluid moves along the bearing clearance B1 may be large, such that the lubricating fluid may move in a state in which it is biased in any one direction, that is, toward the first sealing part 106 or toward the second sealing part 108. In this case, a risk that the lubricating fluid will be leaked from the first and second sealing parts 106 and 108 may be high.

However, as described above, since the connection hole 176 is formed in the outer wall portion 174 of the sleeve 170, even though the lubricating fluid moves in any one direction, the lubricating fluid may move through the connection hole 176. Therefore, the first and second liquid-vapor interfaces F1 and F2 may be stably disposed in the first and second sealing parts 106 and 108, respectively, regardless of internal pressure of the bearing clearance B1.

As a result, the leakage of the lubricating fluid may be prevented.

The rotor hub 180 may be coupled to an upper end portion of the outer peripheral surface of the sleeve 170. Meanwhile, although the case in which the rotor hub 180 is coupled to the sleeve 170 has been described by way of example in the present exemplary embodiment, the present disclosure is not limited thereto. That is, the rotor hub 180 and the sleeve 170 may be formed integrally with each other.

The rotor hub 180 may include a body 182 having a disk shape, a magnet mounting part 184 extended from an edge of the body 182 in a downward axial direction, and a disk support part 186 extended from a distal end of the magnet mounting part 184 in the radial direction.

In addition, the magnet mounting part 184 may include a driving magnet 184a fixedly installed on an inner surface thereof. Therefore, an inner surface of the driving magnet 184a may be disposed to face the stator core 102.

Here, a rotational driving scheme of the rotor 120 will be briefly described. When power is supplied to a coil 104 wound around the stator core 102, driving force capable of rotating the rotor 120 may be generated by an electromagnetic interaction between the stator core 102 around which the coil 104 is wound and the driving magnet 184a to rotate the rotor 120.

That is, the driving magnet 184a and the stator core 102 disposed to face the driving magnet 184a and having the coil 104 wound therearound may electromagnetically interact with each other to rotate the rotor 120.

In addition, the upper and lower radial dynamic grooves may pump the lubricating fluid by the rotation of the rotor 120 as described above, such that the fluid dynamic pressure may be generated. The generated fluid dynamic pressure may allow the rotor 120 to more stably rotate.

Meanwhile, the body 182 may have an installation protrusion 182a protruding in the upward axial direction on an upper surface thereof. A cap member 190 may be installed in the installation protrusion 182a in order to prevent scattering of the lubricating fluid due to the leakage of the lubricating fluid.

The cap member 190 may have a disk shape and rotate with the rotor 120. In addition, the cap member 190 may be bonded to the rotor 120 by at least one of an adhesion method and a welding method.

However, the present disclosure is not limited thereto. That is, the cap member 190 may also be installed on the upper thrust member 160 of the rotor 110.

As described above, since the connection hole 176 is formed in the outer wall portion 174 of the sleeve 170, even though the lubricating fluid moves in any one direction, the lubricating fluid may move through the connection hole 176. Therefore, the first and second liquid-vapor interfaces F1 and F2 may be stably disposed in the first and second sealing parts 106 and 108, respectively, regardless of internal pressure of the bearing clearance B1.

As a result, the leakage of the lubricating fluid may be prevented.

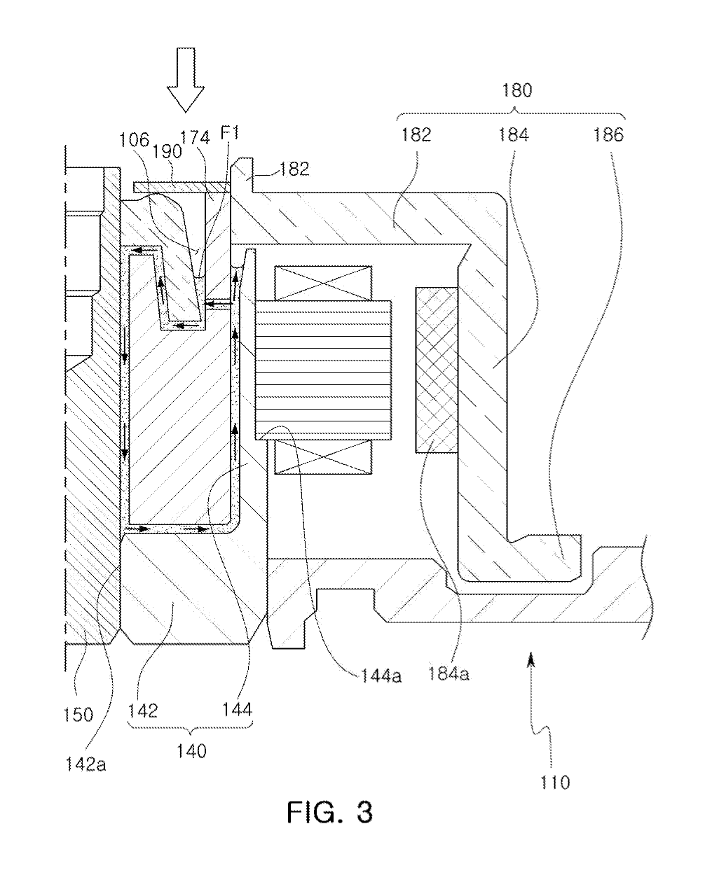

FIG. 3 is a view for describing an operation of the spindle motor according to an exemplary embodiment of the present disclosure.

Referring to FIG. 3, the stator core 102 around which the coil 104 is wound and the driving magnet 184a may electromagnetically interact with each other to generate the driving force for rotating the rotor 120, such that the rotor 120 may rotate. Meanwhile, when the sleeve 170 of the rotor 120 rotates, the fluid dynamic pressure may be generated by the upper and lower radial dynamic grooves formed in the inner peripheral surface of the sleeve 170. Therefore, the lubricating fluid may move by the pressure difference within the bearing clearance B1.

In this case, the negative pressure may be generated in the bearing clearance B1. In this case or in the case in which the external impact is applied to the spindle motor, the lubricating fluid may move in a state in which it is biased toward any one of the first sealing part 106 and the second sealing part 108.

However, since the first and second sealing parts 106 and 108 are connected to each other, even in the case in which the lubricating fluid moves in the state in which it is biased toward any one of the first sealing part 106 and the second sealing part 108, the lubricating fluid may move through the connection hole 176.

Therefore, even though the lubricating fluid moves in the state in which it is biased toward any one of the first sealing part 106 and the second sealing part 108 due to the generation of the negative pressure, the leakage of the lubricating fluid from the first and second sealing parts 106 and 108 may be prevented.

Therefore, the first and second liquid-vapor interfaces F1 and F2 may be stably disposed in the first and second sealing parts 106 and 108, respectively, regardless of the internal pressure of the bearing clearance B1.

As a result, the leakage of the lubricating fluid may be prevented.

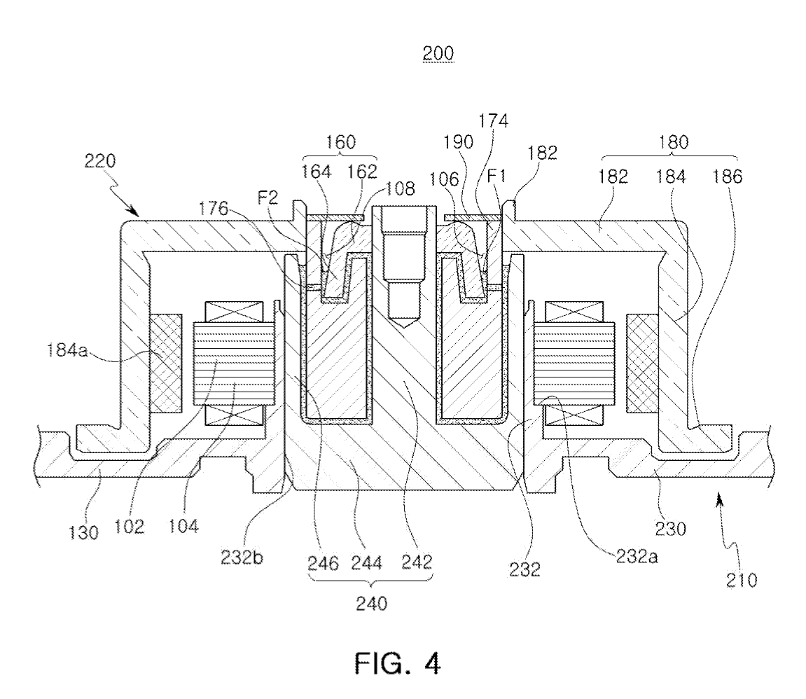

Next, a spindle motor according to another exemplary embodiment of the present disclosure will be described with reference to FIG. 4. However, the same components as the above-mentioned components will be denoted by the same reference numerals and a detailed description therefor will be omitted.

FIG. 4 is a schematic cross-sectional view showing a spindle motor according to another exemplary embodiment of the present disclosure.

Referring to FIG. 4, a spindle motor 200 according to another exemplary embodiment of the present disclosure may include a stator 210 and a rotor 120 by way of example.

Meanwhile, the stator 210 may include a base member 230, a shaft 240, and an upper thrust member 160. Meanwhile, since the upper thrust member 160 of the stator 210 is the same as the upper thrust member provided in the spindle motor 100 according to an exemplary embodiment of the present disclosure described above, a detailed description therefor will be omitted.

Further, since the rotor 120 is also the same as the rotor provided in the spindle motor 100 according to an exemplary embodiment of the present disclosure described above, a detailed description therefor will be omitted.

The base member 230 may include an installation part 232 on which a stator core 102 is installed. That is, the installation part 232 may have the stator core 102 bonded to an outer peripheral surface thereof. To this end, the installation part 232 may have a support surface 232a formed in order to support a lower surface of the stator core 102. As an example, the stator core 102 may be fixed to the installation part 232 to be seated on the support surface 232a of the installation part 232. Here, the stator core 102 may be bonded to the installation part 232 by at least one of a press-fitting method and an adhesion method.

Meanwhile, the installation part 232 may have an installation hole 232b formed therein so that a lower end portion of the shaft 240 may be inserted thereinto. That is, the shaft 240 may be bonded to the installation hole 232b.

The shaft 240 may also form the bearing clearance B1 with the sleeve 170 of the rotor 120. In addition, the shaft 240 may include a shaft body 242 serving as the center of rotation of the sleeve 170, a disk part 244 extended from a lower end portion of the shaft body 242 in the radial direction, and a sealing wall portion 246 extended from an edge of the disk part 244.

An inner peripheral surface of an upper end portion of the sealing wall portion 246 may be inclined so that a first liquid-vapor interface F1 is formed. In addition, the inner peripheral surface of the upper end portion of the sealing wall portion 246 and an outer surface of the sleeve 170 disposed to face the inner peripheral surface of the upper end portion of the sealing wall portion 246 may form a first sealing part 106 in which the first liquid-vapor interface F1 described above is disposed.

As described above, the stator core 102 may be installed on the installation part 232, such that deformation of the sealing wall portion 246 due to installation of the stator core 102 may be prevented. Therefore, a phenomenon that the first sealing part 106 becomes narrow due to the deformation of the sealing wall portion 246 may be prevented.

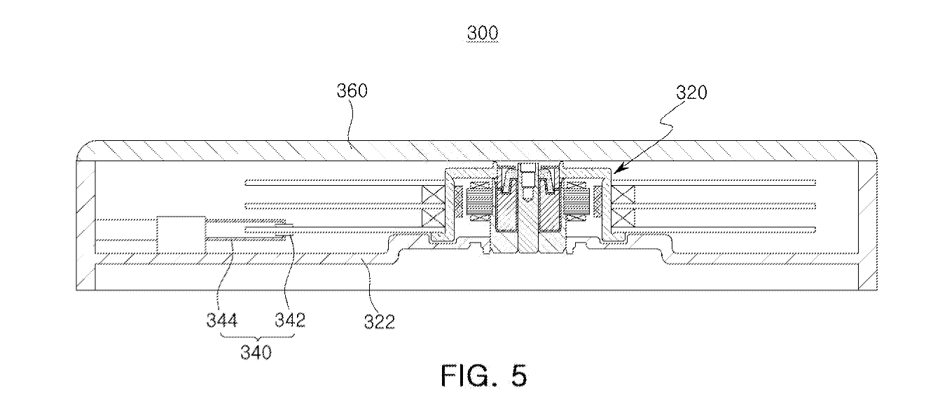

Hereinafter, a hard disk drive according to an exemplary embodiment of the present disclosure will be described with reference to FIG. 5.

FIG. 5 is a schematic cross-sectional view showing a hard disk drive according to an exemplary embodiment of the present disclosure.

Referring to FIG. 5, a hard disk drive 300 according to an exemplary embodiment of the present disclosure may include a spindle motor 320, a head transfer part 340, and an upper case 360 by way of example.

The spindle motor 320 may have a recording disk D mounted thereon. The spindle motor 320 may be any one of the spindle motor 100 according to an exemplary embodiment of the present disclosure and the spindle motor 100 according to another exemplary embodiment of the present disclosure described above.

The head transfer part 340 may transfer a head 342 reading information from the recording disk D mounted on the spindle motor 320 to a surface of the recording disk D of which the information is to be detected. The head 342 may be disposed on a support part 344 of the head transfer part 340.

The upper case 360 may be coupled to a base member 322 in order to form an internal space accommodating the spindle motor 320 and the head transfer part 340 therein.

As set forth above, according to exemplary embodiments of the present disclosure, the leakage of the lubricating fluid may be prevented.

While exemplary embodiments have been shown and described above, it will be apparent to those skilled in the art that modifications and variations could be made without departing from the scope of the present invention as defined by the appended claims.

What is claimed is:

1. A spindle motor comprising:
a stator; and
a rotor forming a bearing clearance with the stator,
wherein the rotor is provided with an insertion groove formed therein into which a portion of the stator is inserted, and
first and second sealing parts having liquid-vapor interfaces formed therein, respectively, are formed inside and outside the insertion groove, respectively,
the first and second sealing parts being in communication with each other via a connection hole.

2. The spindle motor of claim 1, wherein the insertion groove is formed in a sleeve of the rotor forming the bearing clearance with the stator, and the connection hole is formed in an outer wall portion of the sleeve.

3. The spindle motor of claim 2, wherein the stator includes a lower thrust member including a sealing wall portion forming a first sealing part with the sleeve and an upper thrust member forming a second sealing part with the outer wall portion of the sleeve.

4. The spindle motor of claim 3, wherein the stator further includes a shaft having the lower thrust member provided on a lower end portion of the shaft and having the upper thrust member provided on an upper end portion of the shaft.

5. The spindle motor of claim 3, wherein the stator further includes a base member to which a lower end portion of the lower thrust member is bonded.

6. The spindle motor of claim 2, wherein the rotor includes a rotor hub coupled to an upper end portion of the outer wall portion of the sleeve.

7. The spindle motor of claim 3, wherein the sealing wall portion and the upper thrust member are inclined to form the liquid-vapor interface.

8. The spindle motor of claim 4, wherein the lower thrust member and the shaft are formed integrally with each other or are formed separately from each other and are then coupled to each other.

9. A spindle motor comprising:
a base member having an installation hole formed therein;
a lower thrust member inserted into the installation hole of the base member;
a shaft having a lower end portion fixed to the lower thrust member;
an upper thrust member fixed to an upper end portion of the shaft;
a sleeve provided with an insertion groove formed therein into which the upper thrust member is inserted, and forming bearing clearances with the lower thrust member, the shaft, and the upper thrust member; and
a rotor hub fixed to the sleeve to rotate with the sleeve,
wherein an inner peripheral surface and an outer peripheral surface of an outer wall portion of the sleeve, in which the insertion groove is formed, respectively have an liquid-vapor interface formed therein, and
the outer wall portion has a connection hole formed therein to connect the bearing clearances to each other.

10. A hard disk drive comprising:
the spindle motor of claim 1, rotating a recording disk;
a head transfer part transferring a head reading information from the recording disk mounted on the spindle motor to the recording disk; and
an upper case coupled to a base member provided in the spindle motor to form an internal space accommodating the spindle motor and the head transfer part therein.
